(19) United States
(12) Patent Application Publication
(10) Pub. No.: US 2006/0131148 A1
(43) Pub. Date: Jun. 22, 2006

(54) Dustproof structure for an electronic equipment

(75) Inventors: Yoshihiro Noguchi, Chiba (JP); Masahiro Arai, Chiba (JP)

Correspondence Address: BACON & THOMAS, PLLC, 625 SLATERS LANE, FOURTH FLOOR, ALEXANDRIA, VA, 22314, US

(73) Assignee: Futaba Corporation, Chiba (JP)

(21) Appl. No.: 11/298,521

(22) Filed: Dec. 12, 2005

(30) Foreign Application Priority Data
Dec. 10, 2004 (JP) 2004-359244

(51) Int. Cl. H01H 13/06

(52) U.S. Cl. 200/302.2

(57) ABSTRACT

A dustproof structure for an electronic equipment includes internal switches disposed in a housing forming an external frame of the electronic equipment and an opening for use in operating the internal switches. The dustproof structure further includes a shutter plate for opening or closing the opening; and a cover plate for supporting the shutter plate, the shutter plate being freely slidable between the cover plate and the housing. A slide recess serving as a sliding area of the shutter plate is formed in the housing or the cover plate.

### FIELD OF THE INVENTION

The present invention relates to a dustproof structure for preventing dust or the like from entering a housing of an electronic equipment.

### BACKGROUND OF THE INVENTION

Some electronic equipments have internal switches installed inside the equipments. Thus, a housing of such an electronic equipment is provided with an opening for use in manipulating the internal switches from the outside of the housing. Further, such an electronic equipment is conventionally equipped with a dustproof structure for preventing dust particles or the like from entering the housing thereof, and the opening is configured such that it can be opened only when operating the internal switches.

Japanese Utility Model Laid-open Publication No. H5-78295 discloses an example of such a dustproof structure for use in a conventional electronic equipment, e.g., a receiver of a radio controller.

FIGS. 6 to 8 illustrate the receiver of the radio controller disclosed in Japanese Utility Model Laid-open Publication No. H5-78295 (hereinafter, simply referred to as a radio control receiver). Specifically, FIG. 6 is a plan view of the radio control receiver; FIG. 7 is a side view thereof; and FIG. 8 sets forth a plan view of the receiver from which a cover is opened.

As shown in the figures, the radio control receiver 10 includes an approximately box-shaped housing 20. Provided in a lateral surface of the housing 20 are terminals 30 connected to a servo mechanism for driving a power supply battery or a driving unit of an object to be controlled. Also, a linear antenna 40 is drawn out to be extended from the inside of the housing 20 through a lateral surface thereof.

Moreover, a circuit board (not shown) forming a receiver circuit is disposed in the housing 20, and a pair of rotary type dual inline package switches (hereinafter referred to as “DIP switches”) 50 for switching a receive frequency of the radio control receiver 10 are mounted on the circuit board as internal switches. Further, an opening 20a is provided at the housing 20 at a position corresponding to the DIP switches 50 to expose the DIP switches 50 to the outside.

A translucent cover 60 formed of, e.g., a resin material is installed in the housing 20 to be freely slidable over the opening 20a. The cover 60 is of a substantially rectangular shape of a size large enough to cover the opening 20a completely. A cross section of the cover 60 along a direction parallel to a shorter side thereof is of a substantially trapezoid shape, and the cover 60 is installed in the housing 20 to be protruded therefrom. Further, guide grooves 60a are formed at both shorter lateral surfaces of the cover 60.

In addition, protruded portions 20b are formed in the housing 20 along both shorter sides of the opening 20a. By locking the guide grooves 60a of the cover 60 with the protruded portions 20b, the cover 60 can be configured to be slidable with respect to the housing 20.

In this configuration, when operating the DIP switches 50, the cover 60 is slid off the openings 20a to thereby expose the DIP switches 50 for a user to operate them. When the DIP switches 50 need not be operated, the cover 60 is closed to prevent intrusion of dust or the like from outside.

As for such a conventional dustproof structure for the electronic equipment, however, since the cover is installed in the housing of the electronic equipment such that it is protruded to be entirely exposed to the outside, a user's finger or an object can happen to make an unintended contact with the cover to exert an excessive force. At this time, if an excessive load is exerted on the cover such that the cover can be separated from the housing or be damaged.

Moreover, with the recent technological advances, various electronic components included in an electronic equipment are greatly reduced in their sizes and thus the size of the electronic equipment itself is getting smaller as well, while providing same functions.

However, in the conventional dustproof structure for use in the electronic equipment, since the entire cover is attached on the housing as mentioned above, the cover portion may protrude higher than the other surface portion on the same plane. Therefore, the presence of the cover would be an obstacle to the size reduction of the electronic equipment.

### SUMMARY OF THE INVENTION

It is, therefore, an object of the present invention to provide a dustproof structure for an electronic equipment, whose cover plate will not be separated from the equipment or damaged even if it is unintentionally touched or pressed by a user or an object.

In accordance with the present invention, there is provided a dustproof structure for an electronic equipment which includes internal switches disposed in a housing forming an external frame of the electronic equipment and an opening for use in operating the internal switches, the dustproof structure include: a shutter plate for opening or closing the opening; and a cover plate for supporting the shutter plate, the shutter plate being freely slidable between the cover plate and the housing, wherein a slide recess serving as a sliding area of the shutter plate is formed in the housing or the cover plate.

### BRIEF DESCRIPTION OF THE DRAWINGS

The above and other objects and features of the present invention will become apparent from the following description of preferred embodiments given in conjunction with the accompanying drawings, in which:

FIG. 1 is a plan view of a receiver of a radio controller in accordance with a preferred embodiment of the present invention;

FIG. 2 sets forth a right side view the receive shown in FIG. 1;

FIG. 3 provides an exploded perspective view illustrating a configuration of a dustproof structure for use in the receiver in accordance with the preferred embodiment of the present invention;

FIG. 4 depicts a plan view of the receiver in accordance with the preferred embodiment of the present invention, in which a shutter plate is opened;

FIG. 5 presents a plan view of the receiver in accordance with the preferred embodiment of the present invention, in which the shutter plate is closed;

FIG. 6 is a plan view of a receiver of a conventional radio controller;

FIG. 7 offers a right side view of the receiver shown in FIG. 6; and

FIG. 8 sets forth a plan view of the conventional receiver in which a cover is opened.

### DETAILED DESCRIPTION OF THE PREFERRED EMBODIMENTS

Below, a dustproof structure in accordance with a preferred embodiment of the present invention will be described with reference to the accompanying drawings. The dust prevention mechanism is applied to, for example, a receiver of a radio controller. The description will be provided.

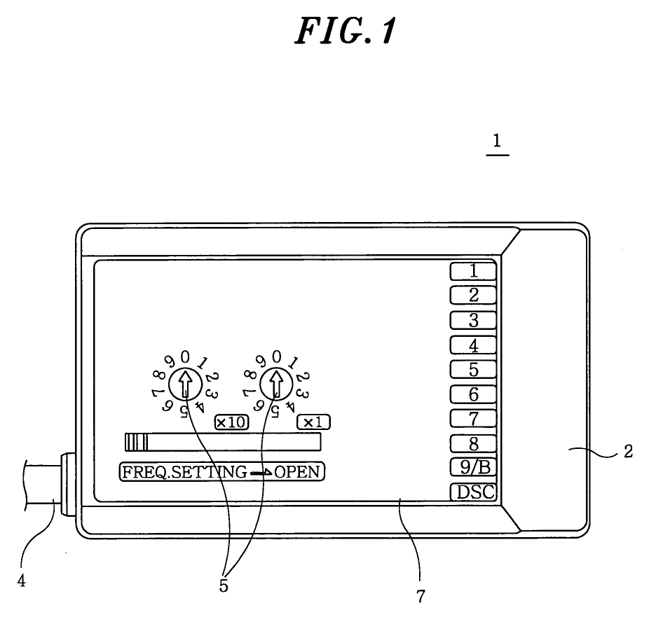

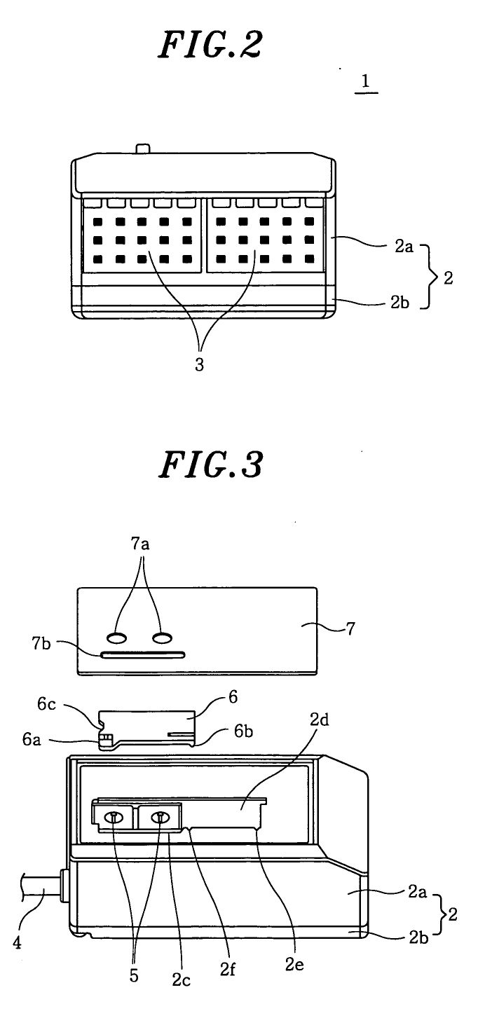

FIG. 1 is a plan view of a receiver 1 of a radio controller (hereinafter, simply referred to as “receiver”) and FIG. 2 is a right side view thereof. FIG. 3 sets forth an exploded perspective view of a dustproof structure of the receiver 1 in accordance with a preferred embodiment of the present invention.

Referring to FIGS. 1 to 3, the receiver 1 includes an approximately box-shaped housing 2. The housing 2 has a casing main body 2a forming a front surface and side surfaces of the housing 2; and a bottom lid 2b forming a bottom surface of the housing 2. The casing main body 2a and the bottom lid 2b are connected to each other as a single body by an engagement of hooks (not shown) and hook recesses (not shown) at their respective one end portions and screw fixations at their another end portions.

The housing 2 has at its side surface terminals 3 to be connected with a servo system for driving a power supply battery or a driving unit of an object to be controlled. Further, the housing 2 has at an opposite side surface a linear antenna 4 drawn out to be extended from the inside of the housing 2.

Further, as shown in FIG. 3, a circuit board (not shown) forming a receiver circuit is disposed in the housing 2, and a pair of rotary type dual inline package switches (hereinafter referred to as “DIP switches”) 5 for switching a receive frequency of the receiver 1 are mounted on the circuit board as internal switches. Also, an opening 2c of an approximately rectangular shape is provided in a front surface of the casing main body 2a at a position corresponding to the DIP switches 5. Through the opening 2c, the DIP switches 5 are exposed to the outside.

The dustproof structure of the receiver 1 in accordance with the present invention includes a shutter plate 6 which is slidable to open or close the opening 2c; a cover plate 7 for supporting the shutter plate 6 such that the shutter plate 6 can be freely slid between the casing main body 2a and the cover plate 7; and a slide recess 2d for forming a sliding area of the shutter plate 6, the slide recess 2d communicating with the opening 2c.

The shutter plate 6 is formed of a transparent or a translucent plate-shaped member made of, e.g., a resin material. The size of the shutter plate 6 is a bit larger than that of the opening 2c, and the shutter plate 6 has a shape capable of covering the entire opening 2c with it when the opening 2c is closed. Also, a manipulation portion 6a for use in sliding the shutter plate 6 is installed at one corner portion of a frontal surface of the shutter plate 6.

The shape of the slide recess 2d is designed to receive the shutter plate 6 therein and allow the shutter plate 6 to be linearly slid next to the opening 2c of the casing main body 2a, to thereby make it possible to open or close the opening 2c freely.

That is, in accordance with the preferred embodiment of the present invention, in order to freely slide the shutter plate 6 along a lengthwise direction thereof to open or close the opening 2c, the slide recess 2d is formed such that the length of a shorter side thereof is substantially identical to that of the shutter plate 6, while the length of a longer side of the slide recess 2d is approximately twice the length of the opening 2c along a lengthwise direction thereof. Further, the slide recess 2d is formed in the surface of the casing main body 2a such that its depth is substantially identical to the thickness of the shutter plate 6.

Accordingly, the shutter plate 6 can be accommodated in the slide recess 2d such that the surfaces of the casing main body 2a and the shutter plate 6 are on a same plane. Further, the sliding movement of the shutter plate 6 is guided by the longer sides of the slide recess 2d while its sliding range is confined by the shorter side of the slide recess 2d. Thus, the shutter plate 6 can be slid linearly within the slide recess 2d while its longer sides are in contact with those of the slide recess 2d, to thereby open or close the opening 2c freely.

The cover plate 7 is formed of an approximately rectangular plate member made of, e.g., a metal material. The cover plate 7 is provided with communication holes 7a communicated with the opening 2c at a position corresponding to the DIP switches 5. Also provided at the cover plate 7 is an elongated hole 7b through which the manipulation portion 6a of the shutter plate 6 is fitted to be linearly moved therein.

Moreover, in the dustproof structure of the receiver 1 in accordance with the preferred embodiment, the cover plate 7 is attached and fixed on the casing main body 2a via an adhesive paper or the like while the shutter plate 6 is slidably received in the slide recess 2d of the casing main body 2a.

In the above-described configuration, by moving the manipulation portion 6a of the shutter plate 6 along the elongated hole 7b linearly, the shutter plate 6 can be slid along the slide recess 2d provided on the casing main body 2a, thus making it possible to expose the DIP switches 5 through the communication holes 7a via the opening 2c or to close the opening 2c such that the DIP switches 5 are not exposed through the communication holes 7a.

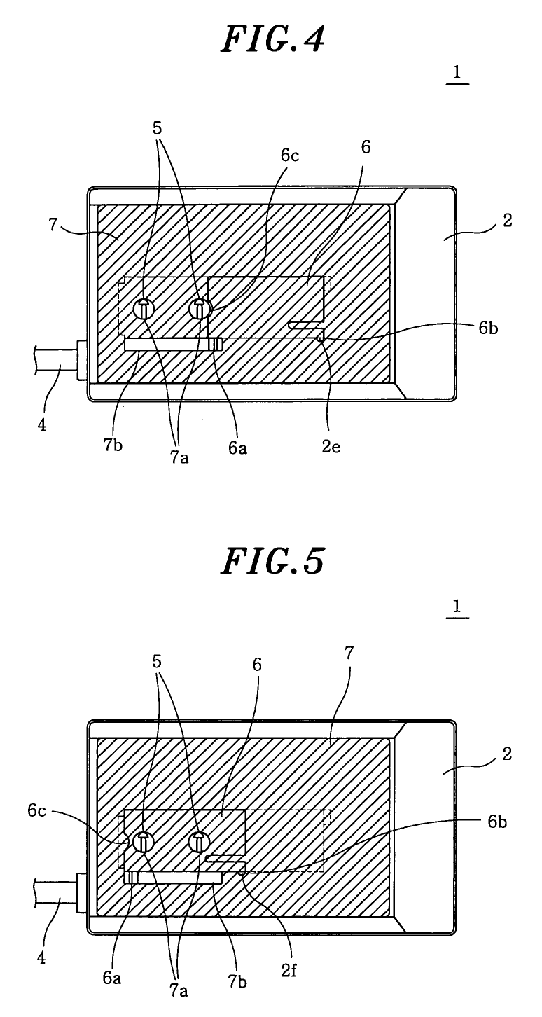

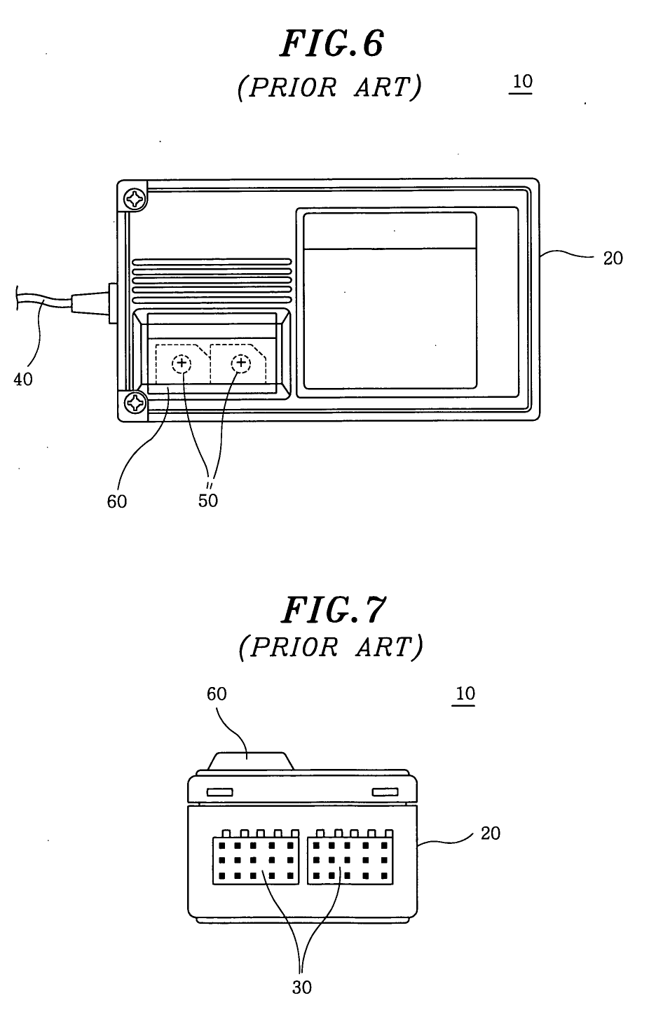

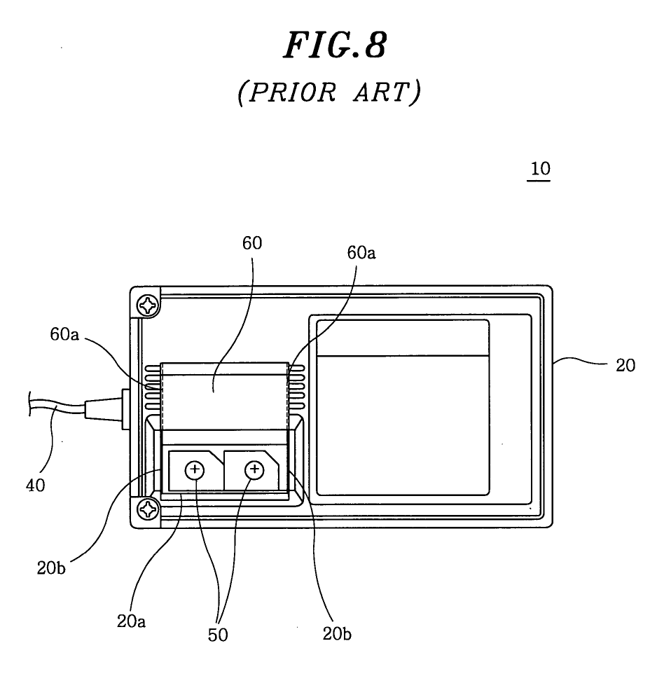

FIG. 4 is a plan view of the receiver 1 in which the shutter plate 6 is opened and FIG. 5 provides a plan view of the receiver 1 in which the shutter plate 6 is closed. In these two figures, the cover plate 7 is shown by hatching.

As shown in FIG. 4, when operating the DIP switches 5, the manipulation portion 6a is moved toward the terminals 3 to thereby expose the DIP switches 5 through the communication holes 7a via the opening 2c, thus allowing a user to operate the DIP switches 5.

Meanwhile, when the DIP switches 5 is not used, the manipulation portion 6a is moved toward the linear antenna 4 to close and protect the DIP switches 5 by the shutter plate 6, as shown in FIG. 5. Thus, it is possible to prevent dust particles or the like from entering the housing 2 from the outside.

Moreover, since the shutter plate 6 is formed of a transparent or a translucent member, the inside of the shutter plate 6 can be seen through the shutter plate 6 even when the DIP switches 5 are closed by the shutter plate 6. So it is possible to observe the operational states of the DIP switches 5.

In the dustproof structure of the receiver 1 configured as described above in accordance with the preferred embodiment, since the shutter plate 6 for opening or closing the opening 2c and the communication holes 7a is covered by the cover plate 7, the shutter plate 6 can be effectively strengthened so that it is made highly durable. Therefore, even in case an excessive force is exerted on the shutter plate 6 by touching the shutter plate 6 or the cover plate 7 with a user's finger or an object unintentionally, the shutter plate 6 can be protected from being separated from the casing main body 2a or damaged. Also, since the dustproof structure is configured to have a flat shape, size reduction of the receiver can be realized.

Further, a protrusion 6b is formed at another corner portion of the shutter plate 6, and a slit is formed at the shutter plate 6 so that it is inwardly extended from the shorter side of the shutter plate 6 at which the protrusion 6b is formed. Also, the slide recess 2d has a first notch 2e and a second notch 2f. The protrusion 6b of the shutter plate 6 is fitted into the first notch 2e to be locked therein when the shutter plate 6 is opened, whereas it is fitted into the second notch 2f to be locked therein when the shutter plate 6 is closed.

Thus, when the shutter plate 6 is opened (as shown in FIG. 4), the protrusion 6b of the shutter plate 6 is locked in the first notch 2e of the slide recess 2d. When the shutter plate 6 is closed (as illustrated in FIG. 5), on the other hand, the protrusion 6b of the shutter plate 6 is locked in the second notch 2f of the slide recess 2d. Therefore, once the shutter plate 6 is opened or closed, it will not be easily slid due to an unintentional touch or vibration.

In addition, when the shutter plate 6 is slid from the first notch 2e to the second notch 2f, the protrusion 6b of the shutter plate 6 is made to slide while it presses a side surface of the slid recess 2d.

As a result, when sliding the shutter plate 6 by using the manipulation portion 6a, it is possible to slide the shutter plate 6 without being vibrated while maintaining an appropriate friction so that manipulation thereof can be facilitated.

Furthermore, an approximately semicircular cutoff portion 6c is formed at one of the shorter sides of the shutter plate 6, whereby the sliding distance of the shutter plate 6 can be reduced when sliding the shutter plate 6 to open or close the communication holes 7a.

Further, a serial number of the receiver 1 is written on the front surface of the cover plate 7, and characters or numbers to be used as operational indicators of the DIP switches 5 are also written on the front surface of the cover plate 7 at positions corresponding to the communication holes 7a. The numbers and the characters are used to assist the manipulation of the DIP switches 5.

Though the dustproof structure for use in an electronic equipment in accordance with the preferred embodiment of the present invention has been described, the present invention is not limited thereto. Each component can be replaced by another element that has a same function. Further, it is also possible to add some elements to the above-descried configuration of the present invention.

For example, though the slide recess which forms the sliding area of the shutter plate is formed in the housing in the above-described preferred embodiment, it is also possible to form the slide recess in the cover plate, wherein the shutter plate is interposed between the cover plate and the housing, or in both of the housing and the cover plate.

Moreover, in the above-described preferred embodiment, though the slide recess serving as the sliding area of the shutter plate is formed in the housing of the receiver along the longitudinal direction thereof, the present invention is not limited thereto. For example, the slide recess may be formed along a direction parallel to the shorter sides of the shutter plate, realizing the same effects.

Further, the dustproof structure for use in an electronic equipment in accordance with the present invention can be applied to various personal or industrial electronic equipments in addition to the radio controller exemplified in the preferred embodiment of the present invention.

While the invention has been shown and described with respect to the preferred embodiments, it will be understood by those skilled in the art that various changes and modifications may be made without departing from the scope of the invention as defined in the following claims.

What is claimed is:

1. A dustproof structure for an electronic equipment which includes internal switches disposed in a housing forming an external frame of the electronic equipment and an opening for use in operating the internal switches, the dustproof structure comprising:
a shutter plate for opening or closing the opening; and
a cover plate for supporting the shutter plate, the shutter plate being freely slidable between the cover plate and the housing,
wherein a slide recess serving as a sliding area of the shutter plate is formed in the housing or the cover plate.

2. The dustproof structure of claim 1, wherein the shutter plate has a manipulation portion for use in sliding the shutter plate; and the cover plate is provided with an elongated hole through which the manipulation portion of the shutter plate is fitted to be linearly moved therein, and a communication hole communicated with the opening.
